(19) United States
(12) Patent Application Publication
(10) Pub. No.: US 2009/0242090 A1
(43) Pub. Date: Oct. 1, 2009

(54) Pneumatic Tire

(75) Inventor: Daisuke Ibaraki, Osaka-fu (JP)

Correspondence Address: FISH & RICHARDSON P.C., P.O. BOX 1022, MINNEAPOLIS, MN, 55440-1022, US

(73) Assignee: Toyo Tire & Rubber Co., Ltd, Osaka-fu (JP)

(21) Appl. No.: 12/401,797

(22) Filed: Mar. 11, 2009

(30) Foreign Application Priority Data
Mar. 25, 2008 (JP) 2008-078172

(51) Int. Cl. B60C 11/117

(52) U.S. Cl. 152/209.3

(57) ABSTRACT

A pneumatic tire has main grooves 1 extending in the tire circumferential direction, plural types of oblong hole groups 21 and 22 in the sidewall 3 of the main groove 1. The oblong hole groups have oblong holes 11 and 12 of the same shapes extending in the groove depth direction of the main groove 1 in the circumferential direction at intervals At least one of the widths w1 and w2, the depths d1 and d2, the spaces p1 and p2 of the oblong holes 11 and 12 differs from those of the other oblong hole groups by 0.1 mm or more, the circumferential lengths r1 and r2 of each oblong hole group is at least 5 mm, the circumferential length of respective oblong hole groups except the longest oblong hole group is not less than 10% of the circumferential length of the longest oblong hole group.

### CROSS-REFERENCE TO RELATED APPLICATION

This application claims the benefit of priority based on Japanese Patent Application No. 2008-078172, the entire same contents of which are incorporated by reference herein.

### BACKGROUND OF THE INVENTION

1. Field of the Invention

The present invention relates to a pneumatic tire with reduced air columnar resonance noise and improved drainage performance.

2. Background Art

In a state where a tire contacts the ground, a tubular space is formed by a main groove extending in the tire circumferential direction and the road surface. The rotation of the tire lets air compressed in the tubular space to release outside and as a result, air columnar resonance noise is generated. Air columnar resonance noise is offensive noise whose frequency is around 1 kHz, and reducing air columnar resonance noise has been requested conventionally. In the pneumatic tire disclosed in the patent document 1 (patent document 1: Unexamined Japanese Laid-Open Patent Publication No. 10-315711 (FIG. 1)), for example, a great number of oblong holes extending in the depth direction of the main groove are provided in the sidewall of the main groove. With these oblong holes, friction resistance against the air flow in the main groove increases and therefore, air columnar resonance noise is reduced.

### SUMMARY OF THE INVENTION

While air columnar resonance noise also has been reduced in the above tire, the demand to reduce tire noise has been markedly stringent recently and reduction in air columnar resonance noise is further requested. Air columnar resonance noise can be reduced by changing the arrangement, width, and shape of the main groove, but there is a risk of decreasing other tire performances such as drainage performance. It is therefore necessary to contrive the shape of oblong holes and further reduce air columnar resonance noise.

Therefore, the object of the present invention is to provide a pneumatic tire with reduced air columnar resonance noise and improved drainage performance.

The pneumatic tire of the present invention has characteristics in that it is the pneumatic tire with main grooves extending in the tire circumferential direction formed on a tread,

wherein multiple types of oblong hole groups in which oblong holes of the same shapes extending in the groove depth direction of the main groove are arranged in the tire circumferential direction at internals are formed in the sidewall of the main groove,

at least one of the width, depth, and space of each oblong hole group is different from those of the other oblong hole groups by 0.1 mm or more,

the circumferential length of each oblong hole group is at least 5 mm and the circumferential length of respective oblong hole groups except the oblong hole group having the longest circumferential length is not less than 10% of the circumferential length of the longest oblong hole group.

With a plurality of oblong holes extending in the groove depth direction of the main groove, the friction resistance against the air flow in the main groove increases. In addition, by arranging multiple types of the oblong hole groups composed of the oblong holes having different shapes, the variation of cross-sectional area in the width direction of the main groove including the main groove and the oblong holes becomes larger. In the result, since the particle velocity of the air flown in the main groove becomes uneven, air columnar resonance noise can be reduced more effectively.

### BRIEF DESCRIPTION OF THE DRAWINGS

FIG. 1 is a view showing the sidewall of the main groove of the pneumatic tire related to the present invention.

FIG. 2 is a view showing a part of the sidewall of the main groove.

FIG. 3 is a view showing the tread pattern of the Examples and the Comparative Examples.

### DESCRIPTION OF THE PREFERRED EMBODIMENTS

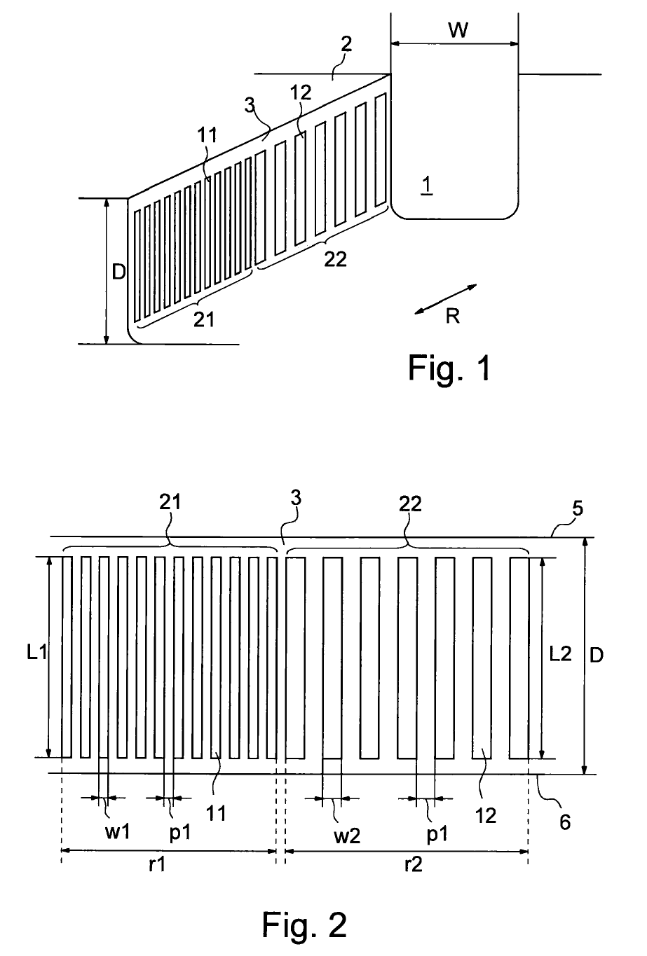

Hereinafter, the embodiments for carrying out the pneumatic tire of the present invention are described using drawings. FIG. 1 is a view showing the sidewall of the main groove of the pneumatic tire related to the present invention and FIG. 2 is a view showing a part of the sidewall 3 of the main groove 1. The main groove 1 extends in the tire circumferential direction R and forms the block 2 together with the transverse groove (not illustrated).

In the sidewall 3 of the main groove 1, two types of oblong hole groups are formed. Accordingly, the first oblong hole group 21 composed of the first oblong holes 11 extending in the groove depth direction and the second oblong hole group 22 composed of the second oblong holes 12 extending in the groove depth direction are formed in the sidewall 3. In each of the oblong hole groups 21 and 22, the oblong holes 11 and 12 are in the same shapes and arranged in the circumferential direction R at constant intervals. However, compared with the oblong holes 11 and 12 of different oblong hole groups, at least one of the width, depth, and space of the oblong holes 11 and 12 is different. Specifically, at least one of the width, depth, and space is different by 0.1 mm or more and when the different amount is less than 0.1 mm, the effects as described below cannot be obtained. Further, implementation is difficult in perspective of processing accuracy. The first oblong hole group 21 and the second oblong hole group 22 are also formed in the sidewall 3 and the opposing sidewall (not illustrated) of the main groove 1.

As well as the conventional tires, with a plurality of oblong holes extending in the groove depth direction of the main groove, friction resistance against the air flow in the main groove increases. By arranging the oblong hole groups 21 and 22 consisting of the oblong holes 11 and 12 having different shapes, the variation of cross-sectional area in the width direction of the main groove 1 including the main groove 1 and the oblong holes 11 and 12 becomes larger. As a result, since particle velocity of the air flown in the main groove becomes uneven, air columnar resonance noise can be reduced more effectively.

On the other hand, by arranging the oblong hole groups 21 and 22 consisting of the oblong holes 11 and 12 having different shapes, turbulent flow is likely to be generated in the water flow that is flown in the main groove when running on the wet road. Consequently, the separation between the water flow and the sidewall 3 is facilitated to enhance the velocity of the water flow, thereby improving drainage performance.

Furthermore, the third oblong hole group consisting of oblong holes having different shapes may be provided and more oblong hole groups than those groups may be provided. In order to reduce air columnar resonance noise effectively and improve drainage performance, the circumferential length of each oblong hole group is preferably at least 5 mm and the circumferential length of respective oblong hole groups except the oblong hole group having the longest circumferential length is preferably not less than 10% of the circumferential length of the longest oblong hole group. Therefore, the structure may be such that the circumferential length of each oblong hole group is not less than 5 mm and equal to each other.

In FIGS. 1 and 2, the circumferential lengths r1 and r2 of the oblong hole groups 21 and 22 are at least 5 mm. The length r1 of the first oblong hole group 21 that has the shorter circumferential length is set to be not less than 10% of the length r2 of the second oblong hole group 21 that has the longer circumferential length.

The lengths L1 and L2 of the groove depth direction of the main groove 1 of the oblong holes 11 and 12 are preferably 50 to 80% of the depth D of the main groove 1. When the length of the groove depth direction is shorter than that range, the effect of reducing air columnar resonance noise lessens. On the other hand, when the length of the groove depth direction is longer than that range, the rigidity of the block 2 is lowered and tire performances may be degraded. From the viewpoint of preventing cracks on the groove bottom 6 of the main groove 1, the oblong holes 11 and 12 are closed preferably at the position shifted toward the tread surface 5 from the groove bottom 6. From the viewpoint of reducing air columnar resonance noise effectively, the structure is preferably such that the oblong holes 11 and 12 do not open on the tread surface 5.

The total surface area Si of all the oblong holes 11 and 12 formed on one side of the sidewall 3 is preferably 10 to 70% of the opening area S2 of the main groove 1. When the range of the total surface area S1 is narrower than the above range, the effect of reducing air columnar resonance noise is decreased. On the other hand, when the range of the total surface area S1 is wider than the above range, the rigidity of the block 2 is lowered and the other tire performances may be degraded. The surface area of oblong holes herein indicates the total area of the sidewalls of five oblong hole surfaces except an opening portion, for example, in the oblong hole 11, it would be

w1×L1+2×w1×d1+2×L1×d1. The opening area of the main groove 1 is the area of the portion opening to the tread over one turn of the main groove 1.

Additionally, inside the surface of the sidewall 3, the oblong holes 11 and 12 may be inclined in the range within 45 degrees to the groove depth direction. When the inclination angle exceeds 45 degrees, the effect of reducing air columnar resonance noise becomes lower.

Defining the width of the main groove 1 as W, it is preferred that the widths w1 and w2 of the oblong holes 11 and 12 are 0.01 to 0.3 time as wide as W, the depths d1 and d2 are 0.01 to 0.3 time as deep as W, the spaces p1 and p2 are 0.2 to 4.0 mm. When the widths w1 and w2 of oblong holes 11 and 12 get narrower, the depths d1 and d2 of the oblong holes 11 and 12 get shallower, and the spaces p1 and p2 between the oblong holes 11 and 12 get wider out of those ranges, the reduction of air columnar resonance noise can not be effectively obtained. On the other hand, when the widths w1 and w2 of the oblong holes 11 and 12 get wider, the depths d1 and d2 of the oblong holes 11 and 12 get deeper, the depths p1 and p2 of the oblong holes 11 and 12 get narrower, the rigidity of the block 2 may be lowered and the other tire performances may be degraded.

### EXAMPLE

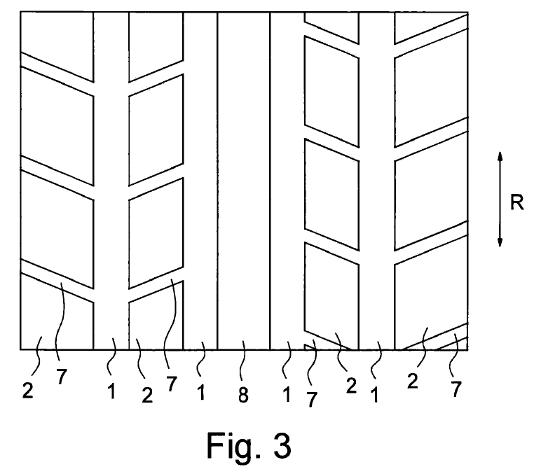

Tires of Examples related to the present invention and Comparative Examples were manufactured and evaluation was made on each of them. As shown in FIG. 3, the tire has the tread pattern in which four main grooves 1 and transverse grooves 7 are formed on the tread, rib 8 is formed in the center portion, and rows of the block 2 are formed on both sides of the rib 8. The evaluation was made under the condition that the tire size was 305/40R22, the rim size was 22×9.5-JJ, and the air pressure was 260 kPa.

The tires of Comparative Examples 1 to 3 were provided with the oblong holes of the same shapes formed in the both sidewalls 3 of all the main grooves 1. The tires of Examples and the tires of other Comparative Examples were the tires with two or three types of oblong hole groups formed in the both sidewalls 3 of all the main grooves 1. The dimensions of respective oblong holes were as shown in Table 1.

The evaluation result is as shown in the Table 1. The noise level is the one obtained by measuring air columnar resonance noise level at 1 kHz of ⅓ octave-band by an engine bench test based on JASO-C606 (at the velocity of 50 km/h) and it is represented by decibel value based on the value of Comparative Example 1. If it is negative value, it indicates that air columnar resonance noise level is reduced.

The drainage performance is the speed in which hydroplaning started to occur when accelerating gradually a four wheel drive SUV with a 5300 cc engine and the tires installed on the wet road whose water depth is 8 mm. Indicating by index numbers on the basis that Comparative Example 1 is set as 100 and the larger value shows the better drainage performance.

TABLE 1

| | | | | | | | Com- | Com- | Com- | Com- | |
|---|---|---|---|---|---|---|---|---|---|---|---|
| | | | | | | | parative | parative | parative | parative | Comparative |
| | | Example 1 | Example 2 | Example 3 | Example 4 | Example 5 | Example 1 | Example 2 | Example 3 | Example 4 | Example 5 |
| First | Width w1 (mm) | 0.5 | 0.5 | 0.5 | 0.5 | 0.5 | 0.5 | 0.5 | 1.0 | 0.1 | 0.5 |
| oblong | Depth d1 (mm) | 0.5 | 0.5 | 0.5 | 0.5 | 0.5 | 0.5 | 0.5 | 0.5 | 0.1 | 0.5 |
| hole | Space p1 (mm) | 2.0 | 2.0 | 2.0 | 2.0 | 2.0 | 2.0 | 2.0 | 3.0 | 2.0 | 2.0 |
| group | Length L1 (mm) | 7.0 | 7.0 | 7.0 | 7.0 | 7.0 | 7.0 | 7.0 | 7.0 | 7.0 | 7.0 |
| | Circumferential | 75.0 | 100.0 | 120.0 | 133.3 | 50.0 | — | — | — | 75.0 | 140.0 |
| | length r1 (mm) | | | | | | | | | | |
| Second | Width w2 (mm) | 1.0 | 1.0 | 1.0 | 1.0 | 1.0 | — | — | — | 0.2 | 1.0 |
| oblong | Depth d2 (mm) | 0.5 | 0.5 | 0.5 | 0.5 | 0.5 | — | — | — | 0.2 | 0.5 |
| hole | Space p2 (mm) | 3.0 | 3.0 | 3.0 | 3.0 | 3.0 | — | — | — | 3.0 | 3.0 |
| group | Length L2 (mm) | 7.0 | 7.0 | 7.0 | 7.0 | 7.0 | — | — | — | 7.0 | 7.0 |
| | Circumferential | 75.0 | 50.0 | 30.0 | 16.6 | 50.0 | — | — | — | 75.0 | 10.0 |
| | length r2 (mm) | | | | | | | | | | |
| Third | Width w3 (mm) | — | — | — | — | 0.3 | — | — | — | — | — |
| oblong | Depth d3 (mm) | — | — | — | — | 0.5 | — | — | — | — | — |
| hole | Space p3 (mm) | — | — | — | — | 2.0 | — | — | — | — | — |
| group | Length L3 (mm) | — | — | — | — | 7.0 | — | — | — | — | — |
| | Circumferential | — | — | — | — | 50.0 | — | — | — | — | — |
| | length r3 (mm) | | | | | | | | | | |

| | | | | | | | | | | |
|---|---|---|---|---|---|---|---|---|---|---|
| (Oblong hole surface area | 20 | 19 | 19 | 18 | 17 | 18 | 18 | 23 | 4 | 18 |
| S1)/(Groove opening area | | | | | | | | | | |
| S2) (%) | | | | | | | | | | |
| Ratio of oblong hole | 1:1 | 2:1 | 4:1 | 8:1 | 1:1:1 | — | — | — | 1:1 | 14:1 |
| circumferential length | | | | | | | | | | |
| Inclination angle of oblong | 0 | 0 | 0 | 0 | 0 | 0 | 45 | 0 | 0 | 0 |
| holes (degree) | | | | | | | | | | |
| Noise level (dB) | −0.5 | −0.5 | −0.5 | −0.2 | −0.5 | — | 0 | −1.0 | +1.2 | 0 |
| Drainage performance | 102 | 103 | 104 | 102 | 103 | 100 | 100 | 98 | 102 | 100 |

Depth of the main groove D: 9.0 mm
Width of the main groove W: 10.0 mm

From the Table 1, it is found that the tires of the Examples show reduced air columnar resonance noise level and improved drainage performance.

What is claimed is:

1. A pneumatic tire provided with main grooves extending in the tire circumferential direction formed on a tread, wherein multiple types of oblong hole groups in which oblong holes of the same shapes extending in the groove depth direction of the main groove are arranged in the tire circumferential direction at internals are formed in the sidewall of the main groove,
at least one of the width, depth, and space of each oblong hole group is different from those of other oblong hole groups by 0.1 mm or more, and
the circumferential length of each oblong hole group is at least 5 mm and the circumferential length of respective oblong hole groups except oblong hole groups having the longest circumferential length is not less than 10% of the circumferential length of the longest oblong hole group.

2. The pneumatic tire as set forth in claim 1, wherein the groove depth direction length of the main groove of the oblong hole of the oblong hole groups is 50 to 80% of D that is the depth of the main groove, the width of the main groove is defined as W, the width of the oblong hole is 0.01 to 0.3 time as wide as W, the depth of the oblong hole is 0.01 to 0.3 time as deep as W, and the space of the oblong hole is 0.2 to 4.0 mm.

3. The pneumatic tire as set forth in claim 1, wherein the total surface area of all the oblong holes formed on one side of the sidewall of the main groove is 10 to 40% of the opening area of the main groove.

4. The pneumatic tire as set forth claim 1, wherein the oblong holes are inclined in the range within 45 degrees to the groove depth direction of the main groove.

5. The pneumatic tire as set forth claim 2,
wherein the oblong holes are inclined in the range within 45 degrees to the groove depth direction of the main groove.
